(19) United States
(12) Patent Application Publication
(10) Pub. No.: US 2012/0015151 A1
(43) Pub. Date: Jan. 19, 2012

(54) ALTERNATING PATTERN GEL CUSHIONING ELEMENTS AND RELATED METHODS

(75) Inventors: Tony M. Pearce, Alpine, UT (US); Terry V. Pearce, Alpine, UT (US); Russell Whatcott, Eagle Mountain, UT (US)

(73) Assignee: EDIZONE, LLC, Alpine, UT (US)

(21) Appl. No.: 13/188,134

(22) Filed: Jul. 21, 2011

Related U.S. Application Data
(63) Continuation-in-part of application No. 12/229,724, filed on Aug. 25, 2008.
(60) Provisional application No. 61/004,460, filed on Nov. 27, 2007.
(60) Provisional application No. 60/997,300, filed on Oct. 2, 2007.
(60) Provisional application No. 60/966,122, filed on Aug. 23, 2007.

(51) Int. Cl. B32B 3/28; B29C 59/02; B32B 3/30

(52) U.S. Cl. 428/156; 428/174; 428/175; 264/293

(57) ABSTRACT

Gel cushioning elements may comprise a sheet of elastomeric gel. The sheet may be shaped and configured to define recesses aligned with and extending into corresponding protrusions. The protrusions are configured to buckle in response to a pressure greater than a threshold pressure. Methods of forming a gel cushioning element may comprise disposing elastomeric gel between two molds having elevated features to impart an alternating pattern to the elastomeric gel, and hardening the elastomeric gel to form a sheet defining a plurality of protrusions. Elevated features of one mold may face elevated features of the other mold, and each elevated feature of one mold may be adjacent an elevated feature of the other mold. A portion of the sheet may be configured to buckle in response to a pressure greater than a threshold pressure. A cushion may comprise a gel cushioning element and fabric bonded to the gel cushioning element.

### CROSS-REFERENCE TO RELATED APPLICATIONS

The present application is a Continuation-in-Part of U.S. patent application Ser. No. 12/229,724, filed Aug. 25, 2008, pending, which claims priority to U.S. Provisional Patent Application Ser. No. 61/004,460, filed Nov. 27, 2007; to U.S. Provisional Patent Application Ser. No. 60/997,300, filed Oct. 2, 2007; and to U.S. Provisional Patent Application Ser. No. 60/966,122, filed Aug. 23, 2007; the disclosures of each of which are hereby incorporated in their entirety by this reference.

### TECHNICAL FIELD

Embodiments of the disclosure relate generally to gels formed into a three-dimensional pattern or alternating pattern such that the pattern is useful as a cushion or as part of a cushioning device.

### BACKGROUND

Cushioning materials have a variety of uses, such as for mattresses, seating surfaces, shoe inserts, packaging, medical devices, etc. Cushioning materials may be formulated and/or configured to reduce peak pressure, which may increase comfort for humans or animals, and may protect objects from damage. Cushioning materials may be formed of materials that deflect or deform under load, such as polyethylene or polyurethane foams (e.g., convoluted foam), vinyl, rubber, springs, natural or synthetic fibers, fluid-filled flexible containers, etc. Different cushioning materials may have different responses to a given pressure, and some materials may be well-suited to different applications. Cushioning materials may be used in combination with one another to achieve selected properties.

### BRIEF SUMMARY

In some embodiments, a gel cushioning element comprises a sheet of elastomeric gel configured to buckle in response to a pressure greater than a threshold pressure. The sheet may be shaped and configured to define a first plurality of protrusions on a first side of the gel cushioning element, a second plurality of protrusions on a second side of the gel cushioning element opposite the first side, a first plurality of recesses on the first side of the gel cushioning element, and a second plurality of recesses on the second side of the gel cushioning element. The recesses of the first plurality of recesses may be aligned with and extend into the protrusions of the second plurality of protrusions, and the recesses of the second plurality of recesses may be aligned with and extend into the protrusions of the first plurality of protrusions. The first plurality of protrusions and the second plurality of protrusions are configured to buckle in response to a pressure greater than a threshold pressure

Methods of forming a gel cushioning element may comprise disposing elastomeric gel between a first mold having a first plurality of elevated features and a second mold having a second plurality of elevated features to impart an alternating pattern to the elastomeric gel, and hardening the elastomeric gel to form a sheet defining a first plurality of protrusions and a second plurality of protrusions. The first plurality of elevated features may face the second plurality of elevated features, and each elevated feature of the first plurality may be disposed adjacent an elevated feature of the second plurality. The first plurality of protrusions and the second plurality of protrusions are configured to buckle in response to a pressure greater than a threshold pressure.

In some embodiments, a cushion comprises a gel cushioning element comprising a sheet of elastomeric gel shaped and configured to define a first plurality of protrusions on a first side of the gel cushioning element, a second plurality of protrusions on a second side of the gel cushioning element opposite the first side, a first plurality of recesses on the first side of the gel cushioning element, and a second plurality of recesses on the second side of the gel cushioning element. A first fabric is bonded to the sheet of elastomeric gel adjacent the first plurality of protrusions, and a second fabric is bonded to the sheet of elastomeric gel adjacent the second plurality of protrusions. The recesses of the first plurality of recesses are aligned with and extend into the protrusions of the second plurality of protrusions, and the recesses of the second plurality of recesses are aligned with and extend into the protrusions of the first plurality of protrusions. The first plurality of protrusions and the second plurality of protrusions are configured to buckle in response to a pressure greater than a threshold pressure.

### BRIEF DESCRIPTION OF THE DRAWINGS

FIG. 1 depicts a cross-section of an exemplary three-dimensionally patterned or alternating pattern gel;

FIGS. 2 and 3 depict top and bottom views of the exemplary three-dimensionally patterned or alternating pattern gel of FIG. 1;

FIGS. 2A and 3A provide alternative depictions of the views of FIGS. 2 and 3;

FIG. 4 depicts another view of the exemplary three-dimensionally patterned or alternating pattern gel of FIG. 1;

FIG. 4A provides an enlarged view of FIG. 4;

FIG. 4B depicts a similar alternating pattern gel;

FIG. 4C depicts yet another alternating pattern gel, but with protrusions on one side and without any such protrusions on its reverse side;

FIG. 5 depicts a cross-section of an exemplary alternating pattern gel mounted to a base, such as foam;

FIG. 5A depicts another view of the exemplary alternating pattern gel mounted to the base of FIG. 5;

FIGS. 6 through 11 depict cross-sections of other embodiments of alternating pattern gels;

FIG. 12 depicts an example exemplary process for making an alternating pattern gel; and

FIGS. 13 through 15 depict cross-sections of other embodiments of alternating pattern gel cushions.

### DETAILED DESCRIPTION

The subject matter hereof relates to gel cushions that use gel or any other elastomer as all or part of the cushions. By gel, we mean an elastomeric gel such as a solid elastomer extended by at least 20 parts plasticizer per 100 parts solid elastomer by weight (20:100). The elastomer could be a hydrogenated poly-isoprene/butadiene (SEEPS), SEBS or SEPS elastomer, or other elastomer, as desired. In some instances, the solid elastomer is extended to at least 50:100 and most preferably by at least 100:100. Some acceptable gels are described by Tony M. Pearce's several patents on gel, such as Gelatinous Elastomer and Methods of Making and Using the Same and Articles Made Therefrom, U.S. Pat. No. 5,994,450, issued Nov. 30, 1999, which is hereby incorporated in its entirety by reference, and which describes multi-block co-polymers with a variety of plasticizers, typically mineral oil. A useful gel is KRATON® E1830 elastomer made by Kraton Polymers, Inc., of Houston, Tex., extended by white food grade mineral oil such as CARNATION® oil. Another useful gel is SEPTON® 4055 elastomer made by Septon Co., U.S.A., and Kuraray America, Inc., extended by CARNATION® oil or other white food grade mineral oil. Other useful gels include polyurethane-based gels, silicone-based gels, PVC-based gels, acrylic-based gels, and many others.

The products and processes herein can also utilize non-gel elastomers in place of the gel elastomers described, but in many cases describe the product as including gel by way of example and for simplicity, but not by way of limitation of the bounds of the invention. For example, instead of gel elastomer, the elastomer can be any of the following: rubber, thermoplastic elastomer, a polyvinyl chloride synthetic rubber, polyurethane, polyurethane film, polyurethane foam, polyurethane memory foam, foamed gel, latex rubber, synthetic latex rubber, latex foam rubber, latex foam, polyolefin, foamed polyolefin (including, but not limited to, foamed polyethylene), or any other flexible or elastic material. According to the present disclosure, an optional addition of hollow microspheres not only lightens the gel and reduces cost, but also can aid in the manufacturing process by changing the characteristics of the gel in the melted or liquid phase. Furthermore, foaming the gel (open cell or closed cell foam) can also be advantageous in reducing weight and/or material cost.

In addition, according to the present disclosure, an alternating patterned gel makes an excellent cushion, for example, for a layer within a mattress. By “alternating patterned gel” it is meant that a gel has one pattern on a first side of a cushioning element, and a like or unlike pattern on the second side, with the most protruding parts of the pattern on the first side being aligned more or less with the least protruding (or most recessed) parts of the pattern on the second side.

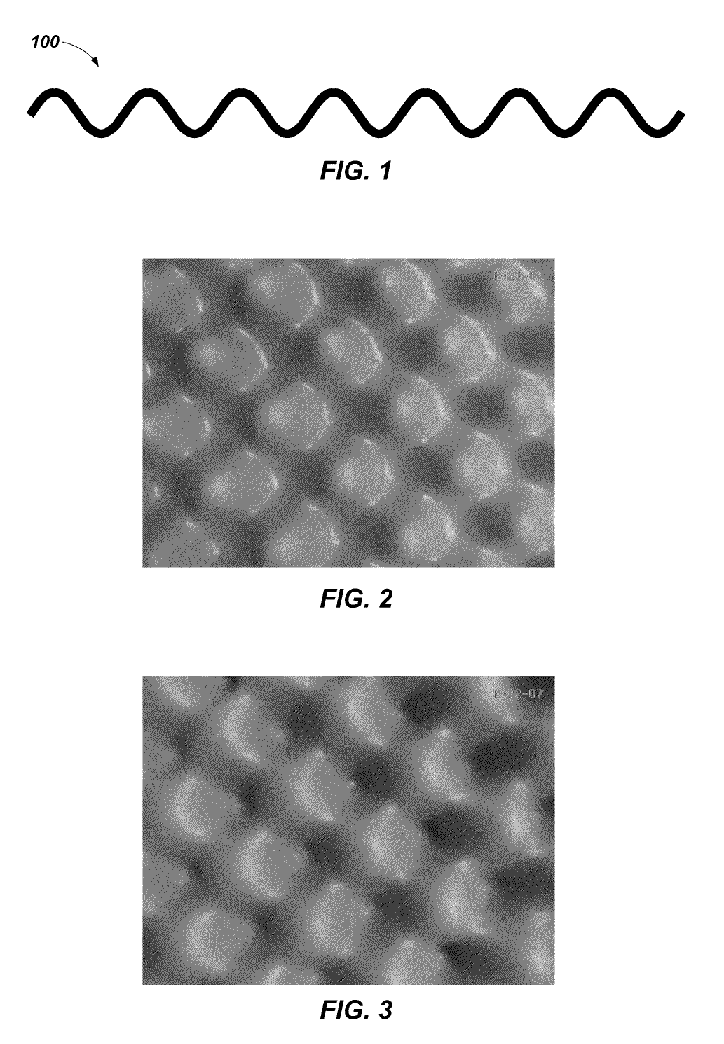

For example, see the cross-section of a cushioning element in FIG. 1. FIG. 1 depicts an exemplary three-dimensionally patterned or alternating pattern gel 100. The “bumps” (e.g., most protruding parts) on the top correspond to the “holes” (e.g., most recessed parts) on the bottom.

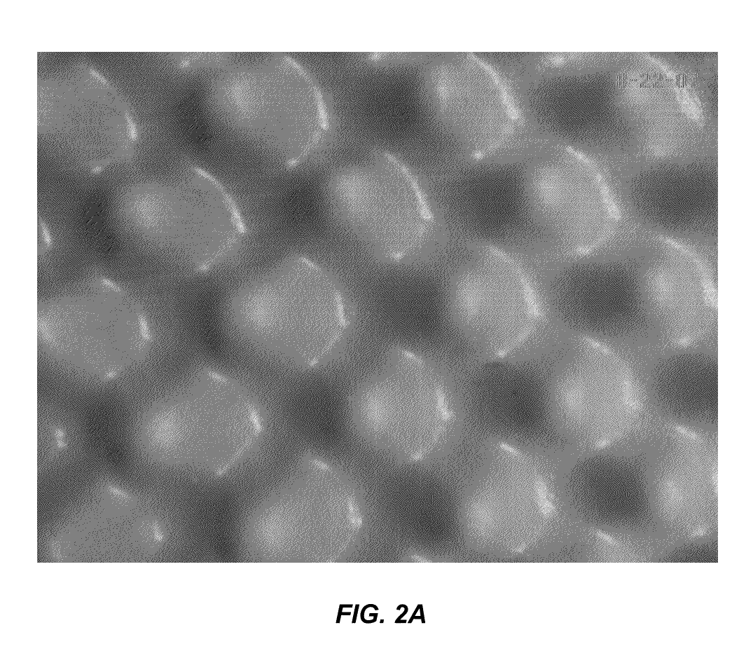

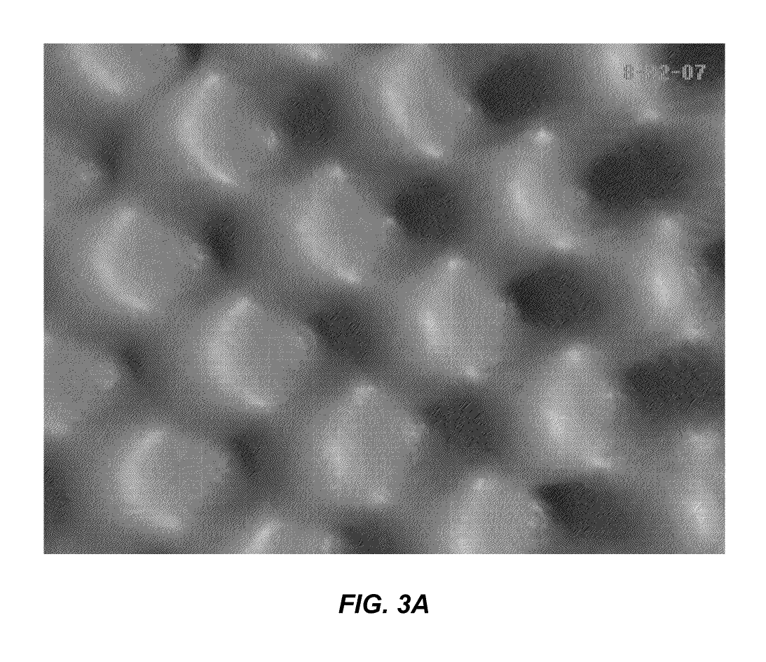

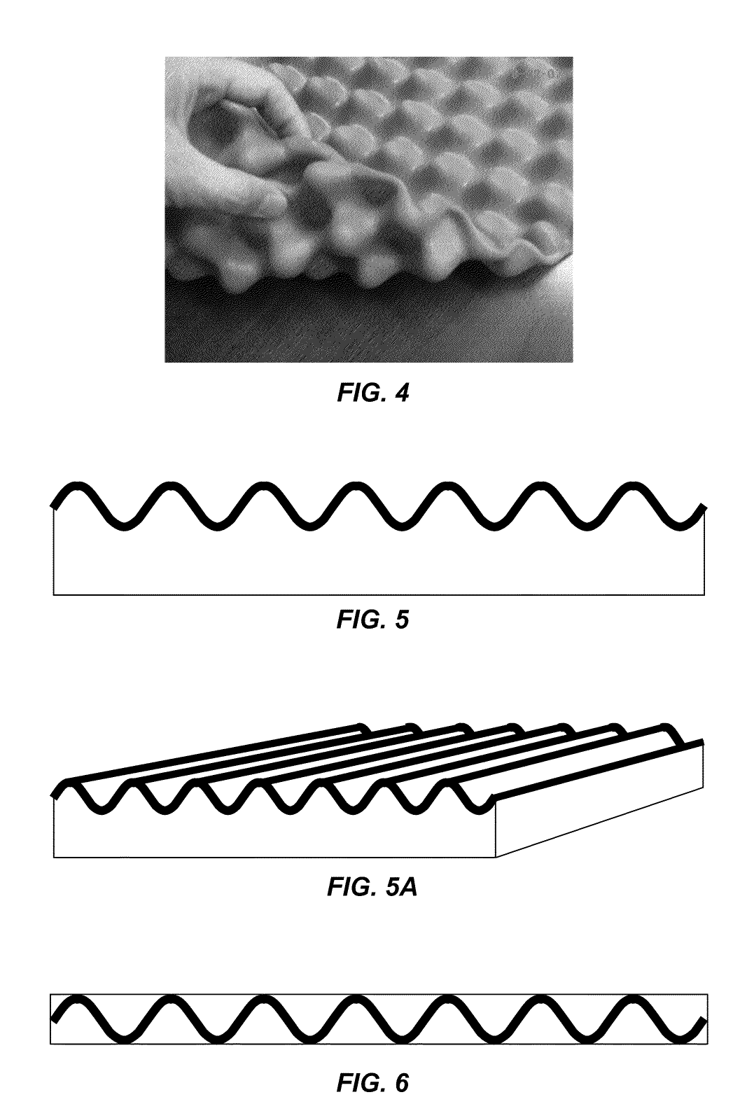

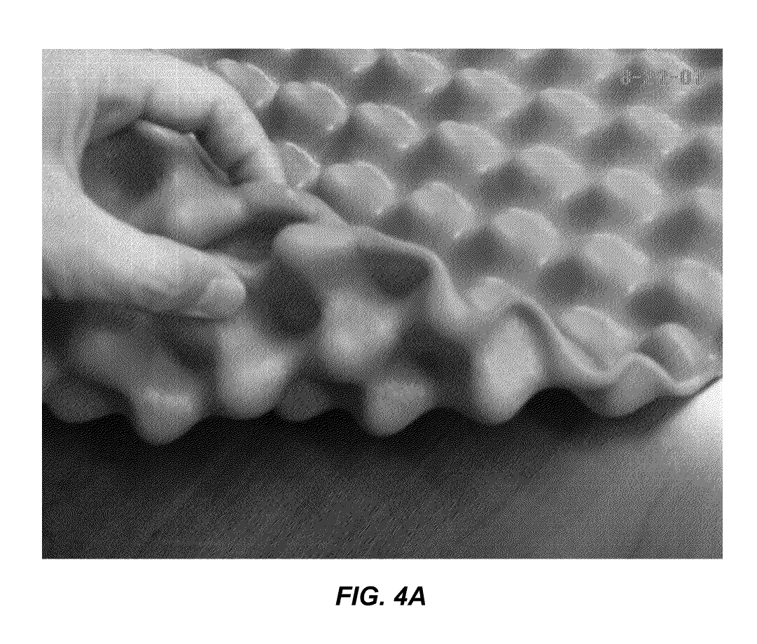

FIGS. 2 and 3 respectively depict top and bottom views of the exemplary three-dimensionally patterned or alternating pattern gel of FIG. 1. As an example, this gel can be made from SEBS elastomer KRATON® E1830 (about 100 parts by weight) and CARNATION® mineral oil (about 300 parts by weight). To this gel may be added 35% by volume glass hollow microspheres of 0.21 specific gravity. FIG. 4 shows both sides of the exemplary three-dimensionally patterned or alternating gel of FIG. 1 at once, demonstrating that the pattern is alternating.

While the appearance of the exemplary three-dimensionally patterned or alternating gel in FIGS. 2 and 3 has some similarity to convoluted foam, there are major differences, and these differences result in substantial structural and performance differences in a cushioning element. For example, convoluted foam is made by compressing a flat piece of foam in a patterned mold, then slicing through it. When the compression is removed, the foam re-expands and has a pattern on one side, rather than having an alternating pattern, such as may be included in the embodiments of the present invention. Further, the alternating pattern gel is not made from compressible foam, but rather from a molded gel, changing both the feel and function, as well as the way it is made.

FIG. 4 depicts another view of the exemplary three-dimensionally patterned or alternating gel of FIG. 1. FIG. 4A provides an enlarged view of FIG. 4. FIG. 4B depicts a similar alternating pattern gel. FIG. 4C depicts yet another alternating pattern gel, but with protrusions on one side and without any such protrusions on its reverse side.

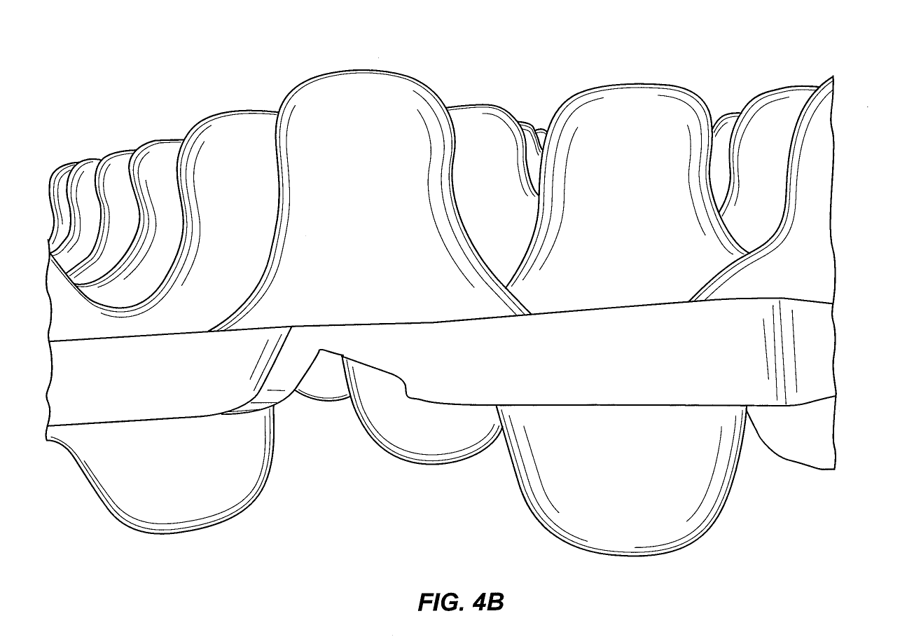

FIG. 5 depicts an exemplary alternating pattern gel optionally mounted to a base, such as a foam. The base may be gel, or another material as desired. The base may be formed to fit the protuberances and recesses of the alternating pattern gel, for a form-fit. Or the base may be otherwise formed, so that the alternating pattern gel contacts the base at the protuberances or otherwise, or across part or all of its surface area. Examples of base material, without limitation, are convoluted polyurethane foam, latex foam, memory foam, etc. An exemplary hybrid cushion would take on some of each of the characteristics of unsupported alternating pattern gel and the base, as well as exhibit an overall unique character.

FIG. 5A shows another view of the exemplary alternating pattern gel of FIG. 5, where the alternating pattern gel is shown to have a two-dimensional pattern, but to be a three-dimensional object. This can apply to any of the cross-sectional shapes applicable to the alternating patterned gel, by simply making the cross-section uniform across the width of the cushioning element. The alternating pattern is not limited to a uniform three-dimensional undulation, but can take many forms, including irregular forms. By way of non-limiting example, the two-dimensional alternating pattern of FIG. 5A would work well with a fabric heat-fused at the top and bottom, and then the fabric glued to a foam base and a foam cap (in this case, unlike FIG. 5, the optional form-fitting base would not be part of it).

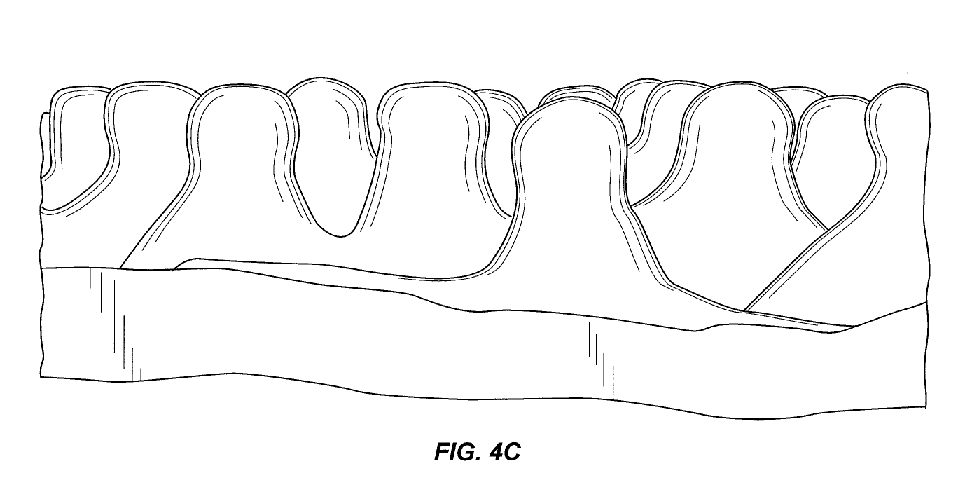

FIG. 6 shows another embodiment that is adapted for easy use as a cushioning element in combination with other cushioning elements or with a base of any kind. Gel is not generally easy to glue to other items (although it is possible with certain adhesives). In the embodiment of FIG. 6, an alternating sine wave gel has a fabric (stretchable or non-stretchable, of any type) heat-fused into the most protruding parts (which can be done on one or both sides). The fabric can then easily be glued to other materials such as foam, mattress ticking fabric, sofa/chair upholstery fabric, a hard or flexible base, another gel cushioning element of this invention that has fabric heat fused into it, or many other things. The embodiment of FIG. 6 makes an excellent cushion because the gel is free to move away from high pressure points. However, the embodiments of FIGS. 5 and 6, both within the scope of the invention, each have applications. For example, a cushioning element of FIG. 5 can be firmer (more supportive), and a cushioning element of FIG. 6 can be more pressure relieving, given the same gel material and configuration. These two may even be used in the same cushion, such as, for example, in a mattress where the cushioning element of FIG. 5 may be placed in an area under the torso to support the back and the cushioning element of FIG. 6 is placed in an area under the hips and shoulders to relieve pressure, or in any other layered configuration.

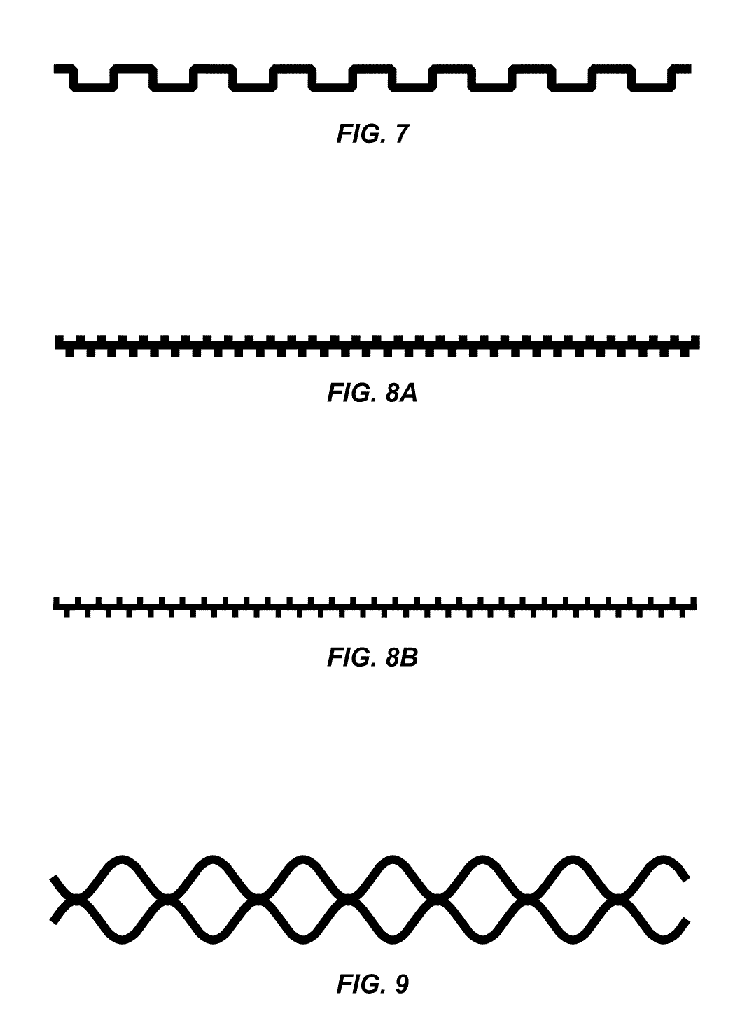

FIG. 7 shows another exemplary embodiment, where the protuberances and recesses are in a square pattern. An infinite variety of patterns are within the scope of the invention.

FIGS. 8A and 8B show two other exemplary embodiments where there are protrusions on an alternating pattern gel, but without corresponding recesses. The protuberances on each side are solid, such as in a “checkerboard pattern” as shown. When picturing a checkerboard, protuberances pointing up could correspond with red squares of a checkerboard and protuberances pointing down (on the opposite side) could correspond with black squares of a checkerboard. Again, in this example where the “bumps” are not hollow, an infinite variety of patterns and shapes are within the scope of the invention.

According to the present disclosure, the alternating pattern gel can be stacked for even more significant pressure relief, or deeper pressure relief For example, FIG. 9 shows a double layer of gel that is heat-fused at the most protruding parts of each “bump.”

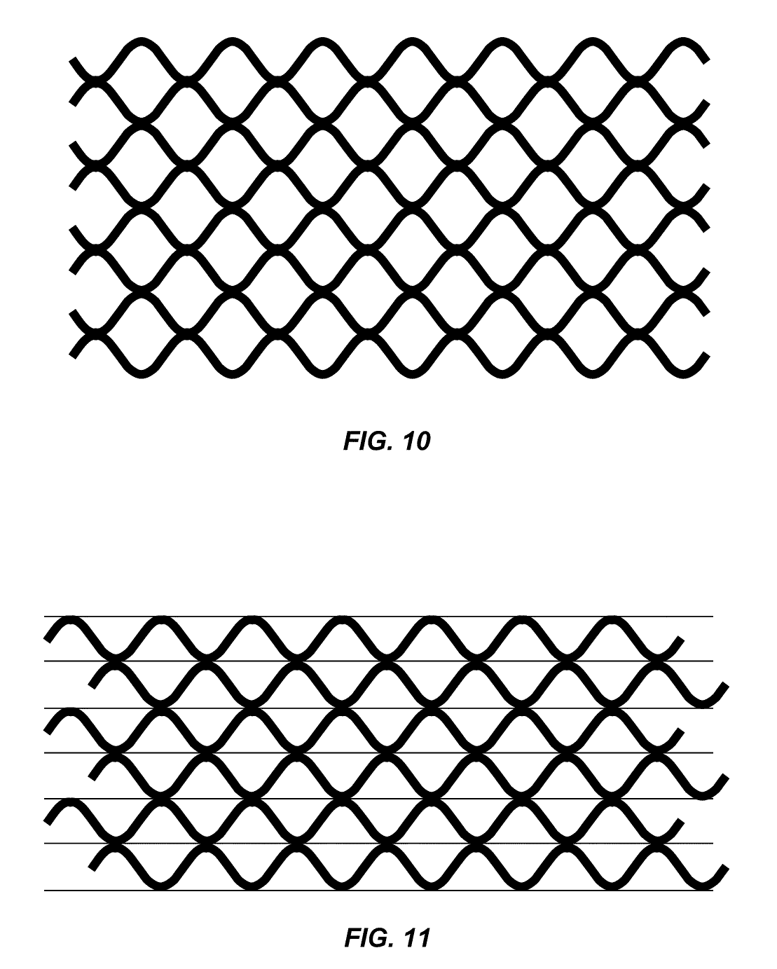

FIG. 10 shows another embodiment of stacked gels, with even more layers of alternating pattern gel, adhesively bonded, heat-fused, solvent-fused, or in other ways, joined.

FIG. 11 shows an embodiment of multiple layers of gel that are joined by heat-fusing fabric at the top and bottom as described above, then adhesively bonding the top fabric on one layer to the bottom fabric of another layer, and repeating this as many times as desired. As an alternative to this, the fabric may be every other layer, with heat-fusing or adhesive bonding taking place every other layer. As another alternative that can have advantageous shear-relieving properties, a layer of elastomeric gel can be used to replace any of the layers of fabric as shown in FIG. 11 or to replace the fabric in any other embodiments of the present disclosure wherein fabric is heat-fused to the gel. Or, to achieve a similar effect, a highly extensible fabric can be chosen, such as a multi-way stretch fabric (such as Spandex or LYCRA®).

The pattern of the alternating pattern gel need not be uniform. It can be variegated to be more pleasing to the eye, or it can be made to be different in different areas (that is to say, “zoned”) to fill different cushioning needs. For example, the pattern can be denser (the “bumps” closer together) in areas of a mattress (such as under the torso) to firm it up (i.e., to provide additional back support), or the pattern can be less dense (the “bumps” spaced farther apart) under the hips and shoulders to provide additional pressure relief The same can be done in different areas of a shoe insole or midsole, for example, to provide more support under the arch and more pressure relief under the ball of the foot. Zoning can be done by varying the gel thickness, by any type of configuration differentiation, or even by varying gel formulation in different parts of the cushion. Even the overall thickness of the cushion (the distance between the upward protrusions and the downward protrusions) can vary within the same cushion.

The pattern of the alternating pattern gel can be any depicted in the figures or described herein, from the list as follows, or any other conceivable pattern that will perform a cushioning function: sine waves, straight-sided, curvy-sided, waves of any other shape (including straight-sided and curvy-sided), square patterns, rectangular patterns, circular patterns, oval patterns, polygon patterns of even-length sides, and polygon patterns with sides of uneven lengths. Also, combinations of the above-listed shapes or other shapes including: combined shapes in each alternating pattern, for example, a square morphing into a circle; and a cushion that is zoned with some patterns of one shape and some of another, like sine waves in one area of the cushion and square patterns in another part, or big sine waves in one part and smaller amplitude sine waves in another part.

The alternating pattern gel is exceptionally good in many cushioning applications, including when used in conjunction with other cushioning elements. Moreover, there is a synergism that is created when the cushion is properly designed from these combinations. Below are some non-limiting examples: alternating pattern gel on top of mattress innersprings; a gel alternating pattern cushion on top of mattress latex foam rubber; alternating pattern gel on top of furniture cushion polyurethane foam; a polyurethane foam alternating pattern cushion on top of a solid slab of mattress polyurethane foam; alternating pattern gel on top of mattress polyurethane foam; 1 inch of latex foam rubber on top of alternating pattern gel, which is, in turn, on top of 3 inches of memory foam in a mattress; 1 inch of polyurethane foam on top of alternating pattern gel, which is, in turn, on top of 3 inches of pocketed coil springs in a sofa cushion; alternating pattern gel on top of a slab of polyurethane foam within a cover as a wheelchair cushion; and so on. The properties of the alternating pattern gel cushion should be designed with the properties of the other cushion(s) used in conjunction to yield the optimum blend of cost, ease of manufacture, and situationally effective cushioning properties.

Without limitation, three-dimensionally patterned gels can be used in the following products: sleeping pads, mattresses, toppers, pillows (bed, sofa, and positioners), shoe and boots (footwear), insoles, sock liners (ankle cushions, cuff cushions), futons, zabutons, furniture (e.g., sofas, loveseats, recliners, ottomans, upholstered chairs, office chairs, medical chairs), theater seating, side chairs, patio and lawn furniture, stadium seats, wheelchair cushions (e.g., seat, back, arm, knee, and head support cushions), massage tables, exam tables, carpet pads, strap cushions (such as for backpacks, fanny packs, golf bags, purses, bras, luggage, briefcases, computer cases, after market/generic), saddle straps, straps of various kinds (such as for horses, climbing, parachute, safety/industrial), automotive, motorcycles and ATVs (seating, trim, headliners, panels) boats (seating, trim, headliners, panels), aircraft (seating, trim, headliners, panels), tool handles, appliance handles, packaging, top of saddle seat cushion, saddle blankets, hoof pads, cushions (neck, seat, knee, between the knee, knee pads, back, lumbar), tumbling/vault pads, other athletic pads (yoga, martial arts, trampoline border pads) protective equipment (sparring, shin, shoulder, wrist, ankle, knee, elbow, hip, neck, kidney, helmets, gloves), medical positioners (surgical positioners, medical positioning cushions, orthotics, braces, slings), pads for casts for broken bones and other immobilization purposes, floor cushion for standing, bicycle gear (seat cushions, handle bars, gloves, saddles, shorts), martial arts mannequins, computer (mouse pads, keyboard/wrist pads), equipment protective bags and cases for computers, cameras, and other equipment, livestock pads (barns and trailers), pet beds, shock absorption, vibration attenuation, gurneys, stretchers, hammocks, toys, baby products (highchairs, cribs, carriers, car seats, teething items, strollers, bassinets), tree collars, any automotive equipment, boating or recreational vehicle cushions or padding, shipping containers for fragile products, all bedding, furniture and footwear products, infant goods that contact the infant, any medical products that contact the human body, and sporting goods of all types, and any other products requiring cushioning characteristics including, without limitation, pressure relief, shock absorption or vibration attenuation.

There are many ways to manufacture an alternating patterned gel, some of which are also embodiments of the present disclosure. For example, the gel may be compression molded (use of a flat sheet of gel compressed between shaped hot platens). The methods below are considered useful in making alternating pattern gel.

### Method No. 1

Obtain or make a flat sheet of gel (with or without microspheres and/or other advantageous additives, such as anti-oxidants, colorant, flame retardants and non-tack additives, and with or without being foamed). An open faced mold is made with the pattern into which the gel is to be formed, and the mold is heated to a temperature in which the gel will melt or partially melt or soften or flow. The flat sheet of gel is placed on the heated open faced mold, and the sheet melts or partially melts, or softens or flows and assumes the shape of the pattern. Gravity may be used to encourage such flow. The flat sheet of gel material drapes to form to the pattern shape, then is cooled (which solidifies it and makes it so it can be handled) and it is then pulled off the mold. An alternating pattern gel is the result. The mold is then reheated, and a new sheet is placed on it and the process is repeated. In an alternative, a heat source can be applied to the top of the sheet of gel to help it drape or flow, and air flow or fluid flow can be exposed to the gel sheet to encourage it to conform to the shape of the mold.

### Method No. 2

An open faced mold (which may be room temperature or heated above or cooled below room temperature, depending on the materials used) is put in motion relative to the molten gel coming out of an extrusion flat-sheet die onto the mold with the mold having the desired pattern. The material is allowed to cool and is removed from the mold and an alternating pattern gel results.

By way of example, the open faced mold may be aluminum, steel or other material, and may be at a temperature which is sufficiently less than the melt temperature of the gel (when the thermal masses of the mold and the gel are taken into account) to “freeze” the gel (e.g., cool it until it is solid and removable), such as 90° F. The stationary extrusion sheet die may, for example, extrude a ⅛ inch thick, 60 inches wide sheet of molten KRATON® E1830/oil gel, which exits the extruder at 375° F. The mold is conducted so that the molten sheet of gel extrudes onto the moving mold, drapes into the pattern of the mold, and then freezes by reducing in temperature to 100° F. and is removed by pulling either by hand or by machine. This process can be made continuous, with the mold pattern being on a continuous belt or on the surface of a rotating cylinder or in discrete pieces that are rotated through the process to fit end-to-end so that there is always a “fresh” mold face moving beneath the melted gel exiting the extrusion die. As an alternative, a heat source can be applied to the top of the sheet of gel to help it drape or flow. Optionally, a source of pressure can be applied at any of a number of temperatures to help the sheet of gel to drape into the mold recesses. For example, a hard or soft material can be used as a pusher, such as, for example, a wheel with hard or soft (e.g., elastomeric or foam) bumps that can continuously rotate to push the molten gel sheet into the recesses. The bumps on the wheel can be any temperature. As another example, air, gas, or liquid of any temperature can be blown onto the surface of the molten sheet of gel to push it into the recesses of the open face mold. In another alternative, the mold is much hotter than will allow the gel to freeze, then after the gel drapes, the mold is cooled so that the gel freezes, for example, by spraying water on the underside of the mold, or on the surface of the gel, or both, to cool the gel.

### Method No. 3

This method is similar to Method No. 2 except that the mold is convoluted (or otherwise patterned) foam. The molten gel material is allowed to cool to room temperature, and can be left on the foam or base (such as in the embodiment of FIG. 5) or pulled off the foam or base. Depending on the melt viscosity of the gel and the porosity of the foam, the gel may or may not adhere to the foam, either of which is useful in making a cushion.

### Method No. 4

This method may be similar to Method Nos. 2 or 3, except that instead of extruding a sheet of molten gel onto the patterned mold, it is applied by other means, including, but not limited to, spraying or pouring of the molten gel onto a mold. The gel is then removed after it cools sufficiently, or if the mold is made of a foam, the gel may be left in place. The gel may be sprayed with a variety of means, including but not limited to, the type of spray equipment that is made to spray hot melt adhesive.

### Method No. 5

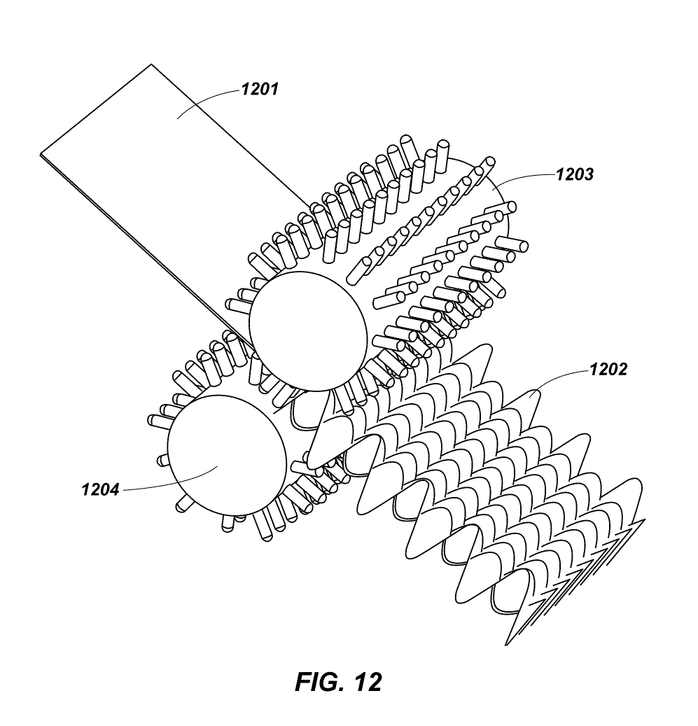

Referring to FIG. 12, a sheet 1201 of molten gel coming out of an extrusion sheet die machine (not shown) can be directed between two rollers 1203 and 1204 with the desired alternating pattern on each roller 1203, 1204 (which pattern will be impressed into the gel) or with the desired alternating pushing devices (such as that defined by the illustrated pins). In some cases, such as in the two rollers 1203 and 1204 of FIG. 12, the rollers have protrusions that are intended only for pushing the gel and do not of themselves have the final shape of the gel. In the case of rollers 1203, 1204, pins are shown that push on each side of a molten sheet of gel, causing a protrusion in the gel on the side opposite the pins and a recess at the location on which the pin bears. As there are two rollers 1203, 1204, the pins on one roller are spaced between the pins on the other roller, and the pins push in opposing directions, which causes the molten or semi-molten gel to stretch, move and form itself into a desired shape. Where the two rollers 1203, 1204 have the final shape of the alternating pattern rather than just having pushing protrusions, the rollers can optionally be temperature controlled to solidify the gel sheet into the desired shape. An alternating pattern gel 1202 results as the gel sheet is pulled through the two rollers 1203, 1204. The pictured embodiment of the gel production could use the two rollers 1203, 1204 with pegs instead of pins. The two rollers 1203, 1204 can have protrusions such as, for example, rows of pegs that are spaced lengthwise along the rollers 1203, 1204 and also around the circumference. The spacing of the pegs directly determines the final geometry of the gel component. The spacing on the two rollers 1203, 1204 can alternate in opposing alignments so that the pegs press the gel toward the opposite direction and past the tip of the pegs of the opposing roller. This twin roller system can be set up at a specified distance from the output of the extrusion machine so that rollers 1203, 1204 will not contact the extrusion machine, but so that the material enters the rollers 1203, 1204 as close to the machine temperature as possible. Some shielding may be performed, along the lines of an oven (not shown), between the end of the extruder and the rollers 1203, 1204 so that the gel material remains pliable for as long as needed. The two rollers 1203, 1204 can be timed to each other and a speed can be used to maintain the proper thickness of the final part. The faster the rollers 1203, 1204 go, relative to the melted material flow, the thinner the gel material may tend to be. As the melted material enters the rollers 1203, 1204, the opposing pegs can push past each other forming the final part. Because of the nature of the gel material, the outer surface cools quickly and the parts of the gel material can either be immediately removed or they can remain on one roller, or the other, as they pass through a cooling bath for more complete solidification. This part of the gel material is then easily removed.

Instead of using two opposing rollers, this extruding method could also be performed using one lower roller having an upper, sliding peg mechanism. This upper, sliding peg mechanism would press and slide along with the lower roller to reduce deformation, then retract from the gel and repeat the process. The upper, sliding peg mechanism is timed with the roller so that there are not peg-on-peg collisions and thus creates the desired part. This particular method could also be performed with two sliding and pressing platens that have spaced apart and aligned pegs instead of using one roller. Additionally, an upper mechanism can be the above-described sliding and pressing platens and a lower piece could be a discrete platen that is timed as it slides, or is pulled under the extrusion machine but is stopped and removed when a single part is completed.

At least some of the above methods can employ mechanisms with aligned and oriented pegs. The patterned gel can also be made using a mold base (flat or in roller configuration) that is contoured to the shape of a desired final part of the alternating pattern gel instead of using spaced pegs. This contoured piece could then run (with careful timing) under an extrusion outlet and a thin film of material can be placed on the mold. At this point, an operator or mechanism can push the film down into the contoured mold cavity using a compliant peg until the film is against the mold surface. The compliance of the molding peg, or set of pegs, allows the film of material to stretch evenly as it conforms to the shape of the contoured mold.

Some of the above methods allow for continuous molded parts of alternating pattern gel, while others are more suited for discrete parts. Continuously molded parts will allow, generally, for higher production rates and lower part cost, while the discrete parts may allow for more adapted or customized parts. These parts of the alternating pattern gel could be ones that are, for example, zoned with different arrangements of the pegs or adding details such as a company logo or a product name.

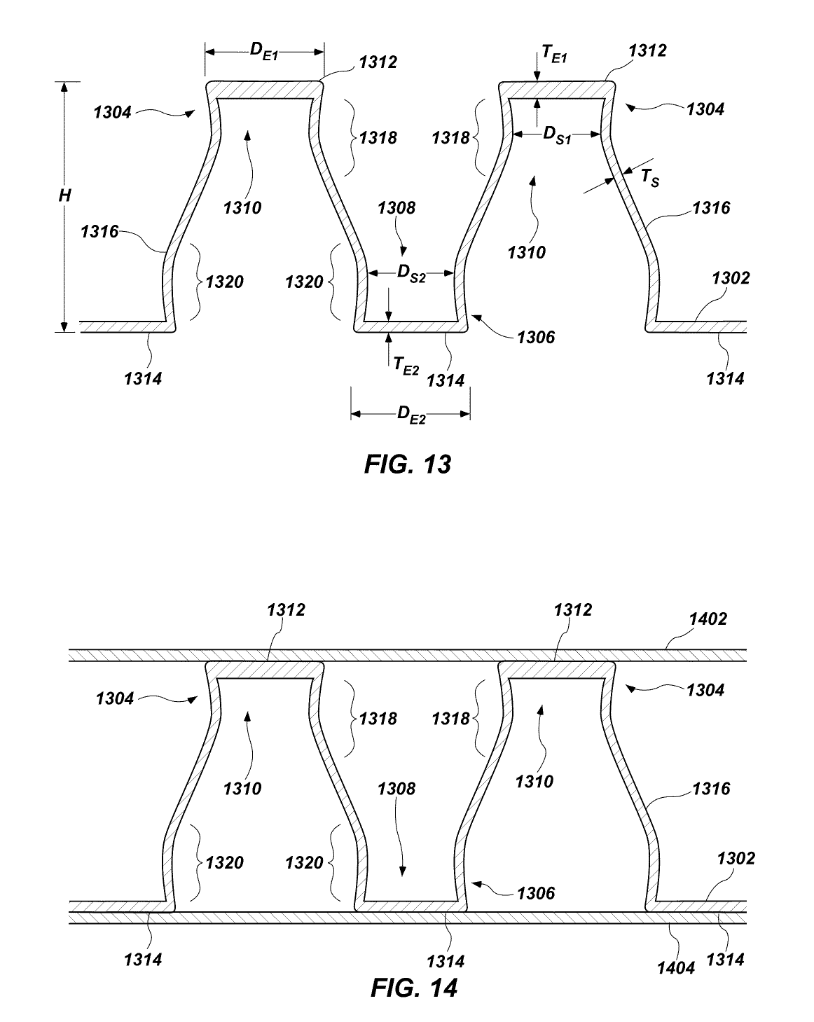

FIG. 13 shows a cross-section of a three-dimensionally patterned or alternating gel like that shown in FIG. 4B. The gel so configured may be a gel cushioning element. The gel cushioning element comprises a structured sheet of elastomeric gel 1302. The sheet 1302 is shaped and configured to define first protrusions 1304, second protrusions 1306, first recesses 1308 (only one recess 1308 depicted in FIG. 13), and second recesses 1310. For example, the first protrusions 1304 and the first recesses 1308 may be on a first side (e.g., an upper side from the perspective of FIG. 13) of the sheet 1302. The second protrusions 1306 and the second recesses 1310 may be on a second, opposite side of the sheet 1302 (e.g., a lower side from the perspective of FIG. 13). Each of the first protrusions 1304 may be disposed laterally adjacent at least one first recess 1308 (e.g., a first protrusion 1304 may be between the at least one recess 1308 on the same side of the sheet 1302, horizontally, as shown in FIG. 13). Each of the second protrusions 1306 may be disposed laterally adjacent at least one second recesses 1310.

The first recesses 1308 may be aligned with and extend into the second protrusions 1306, and the second recesses 1310 may be aligned with and extend into the first protrusions 1304.

The sheet 1302 may include first endwalls 1312 and second endwalls 1314. The first endwalls 1312 may define a portion of the first protrusions 1304 and a portion of the second recesses 1310. The first endwalls 1312 may have a first average endwall thickness T_{E1}. The second endwalls 1314 may define a portion of the second protrusions 1306 and a portion of the first recesses 1308, and may have a second average endwall thickness T_{E2}. In some embodiments, the first endwall thickness T_{E1} and the second endwall thickness T_{E2} may be approximately equal. The first endwalls 1312 and the second endwalls 1314 may each have a generally planar face with an approximately circular shape (e.g., when viewed from a direction normal to the cross-sectional view of FIG. 13). In embodiments having an approximately circular planar face, the first endwalls 1312 and second endwalls 1314 may have diameters D_{E1} and D_{E2}, respectively. The diameters D_{E1} and D_{E2} may or may not be identical.

Other portions of the sheet 1302 may define and comprise sidewalls 1316 connecting the first endwalls 1312 to the second endwalls 1314. The sidewalls 1316 may have an average sidewall thickness T_{S}. The average sidewall thickness T_{S} may be less than or equal to the first endwall thickness T_{E1} and less than or equal to the second endwall thickness T_{E2}. For example, the first endwall thickness T_{E1} and/or the second endwall thickness T_{E2} may be at least 10% (ten percent) larger than the average sidewall thickness T_{S}, at least 30% larger than the average sidewall thickness T_{S}, or even at least 50% larger than the average sidewall thickness T_{S}. Though the sidewalls 1316 appear as several distinct elements in the two-dimensional cross-sectional view of FIG. 13, the sidewalls 1316 may be defined by and comprise a single, continuous portion of the sheet 1302.

The sidewalls 1316 may include first generally cylindrical portions 1318 and second generally cylindrical portions 1320. The first generally cylindrical portions 1318 may each surround one of the first endwalls 1312, and the second generally cylindrical portions 1320 may each surround one of the second endwalls 1314.

The generally cylindrical portions 1318 and 1320 may be slightly bowed inward, and may have minimum inside diameters D_{S1} and D_{S2}, respectively. The average minimum inside diameter of the first plurality of generally cylindrical portions 1318 may be defined as the average of the minimum diameters D_{S1} of all of the first generally cylindrical portions 1318. Similarly, the average minimum inside diameter of the second plurality of generally cylindrical portions 1320 may be defined as the average of the minimum diameters D_{S1} of all of the second generally cylindrical portions 1320. The minimum inside diameters D_{S1} and D_{S2} may be smaller than diameters D_{E1} and D_{E2} of the first endwalls 1312 and second endwalls 1314, respectively. For example, the minimum inside diameters D_{S1} and D_{S2} may be 0.5%, 1.0%, 3%, 5%, 10%, 20%, or 30% smaller than diameters D_{E1} and D_{E2}. In some embodiments, the minimum inside diameters D_{S1} and D_{S2} may be the same size as diameters D_{E1} and D_{E2}. In other embodiments, the minimum inside diameters D_{S1} and D_{S2} may be more than 30% smaller than diameters D_{E1} and D_{E2}.

The first protrusions 1304 and the second protrusions 1306, and, more particularly, the generally cylindrical portions 1318 and 1320, may be configured to buckle or fold under an applied force or pressure greater than a threshold force or pressure. A general description of buckling may be found in U.S. Pat. No. 7,076,822, issued Jul. 18, 2006, titled Stacked Cushions, the disclosure of which is incorporated herein in its entirety by this reference. The threshold force or pressure may vary based on the dimensions T_{S}, D_{S1}, D_{S2}, T_{E1}, T_{E2}, D_{E1}, and/or D_{E2}. Furthermore, the threshold force or pressure may vary based on a height H of the sheet 1302 (i.e., the vertical distance between a top of the first protrusions 1304 and a bottom of the second protrusions 1306, as viewed in FIG. 13). The threshold force or pressure also may vary based on the material from which the sheet 1302 is made, or on the temperature, or other environmental conditions. The first protrusions 1304 and the second protrusions 1306 can be urged or caused to buckle in the regions of the respective generally cylindrical portions 1318 and 1320 by configuring the first endwalls 1312 and second endwalls 1314 to be thicker than the generally cylindrical portions 1318 and 1320, and by causing the generally cylindrical portions 1318 and 1320 to be slightly bowed inward.

The relatively thicker first endwalls 1312 and second endwalls 1314 together may provide planar bases on opposing sides of the sheet of elastomeric gel 1302 to which other layers of material (e.g., cushioning material, fabric, etc.) may be bonded.

For example, FIG. 14 shows flexible support members 1402 and 1404 attached to the sheet of elastomeric gel 1302 to form a cushion or cushioning element. Also, for example, the flexible support members 1402 and 1404 may be heat-fused to the sheet of elastomeric gel 1302. The flexible support members 1402 and 1404 may include a material formulated to deform without stretching, such as a flexible fabric. The flexible support members 1402 and 1404 may alternatively include materials formulated to deform and stretch, such as an elastomeric gel (of the same or of a different composition as that of the sheet of elastomeric gel 1302) or a stretchable fabric such as those that include Spandex or LYCRA® elastic fibers. The flexible support member 1402 may include the same material as the flexible support member 1404, or the two flexible support members 1402 and 1404 may include different materials. The flexible support members 1402 and 1404 may have the same or different configurations (e.g., thicknesses, densities, etc.). The flexible support members 1402 and 1404 may be bonded or fused to the first endwalls 1312 and second endwalls 1314, respectively. The flexible support members 1402 and 1404 may change the threshold force or pressure above that which the sheet 1302 buckles. Further, because the flexible support members 1402 and 1404 are bonded to the first endwalls 1312 and second endwalls 1314 of each of the first protrusions 1304 and the second protrusions 1306, as one protrusion buckles, compresses, or otherwise deforms, the flexible support members 1402 and 1404 will pull on adjacent protrusions. As a result, the overall compressible and cushioning behavior of a cushion can be adjusted and tailored, as desirable using the flexible support members 1402 and 1404.

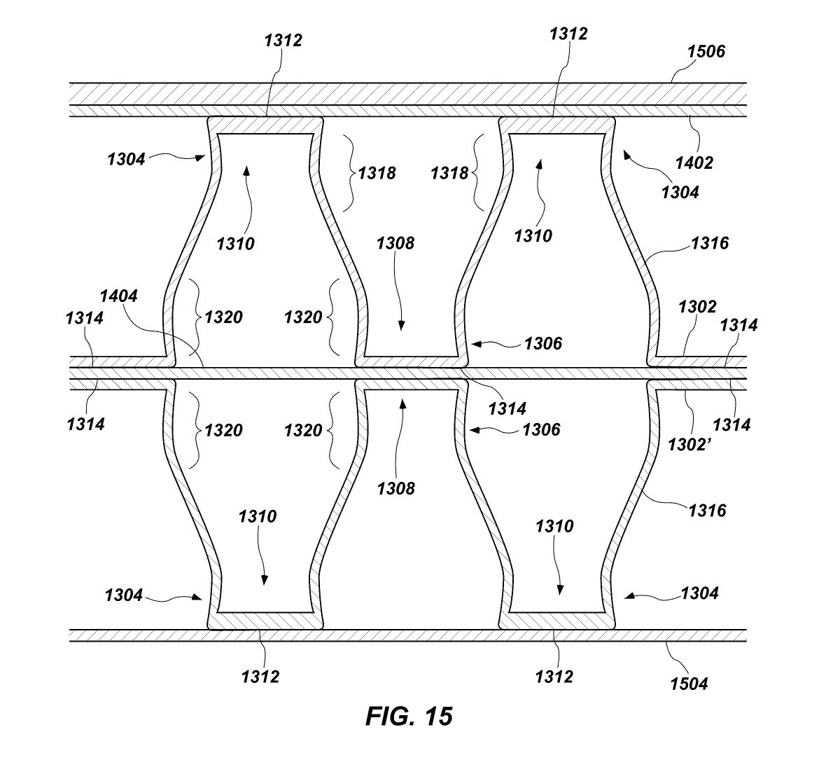

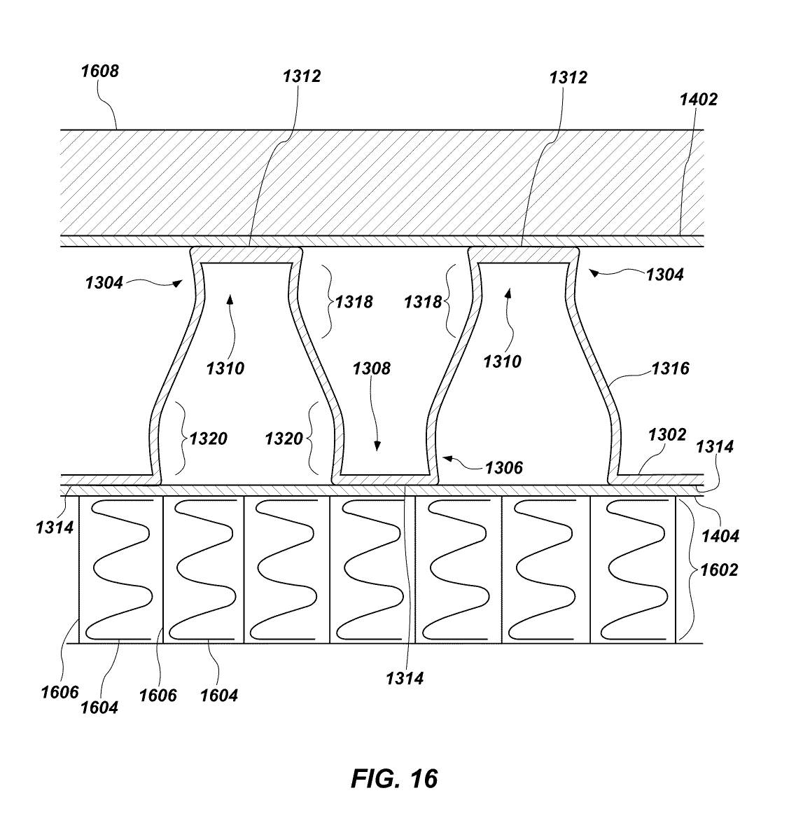

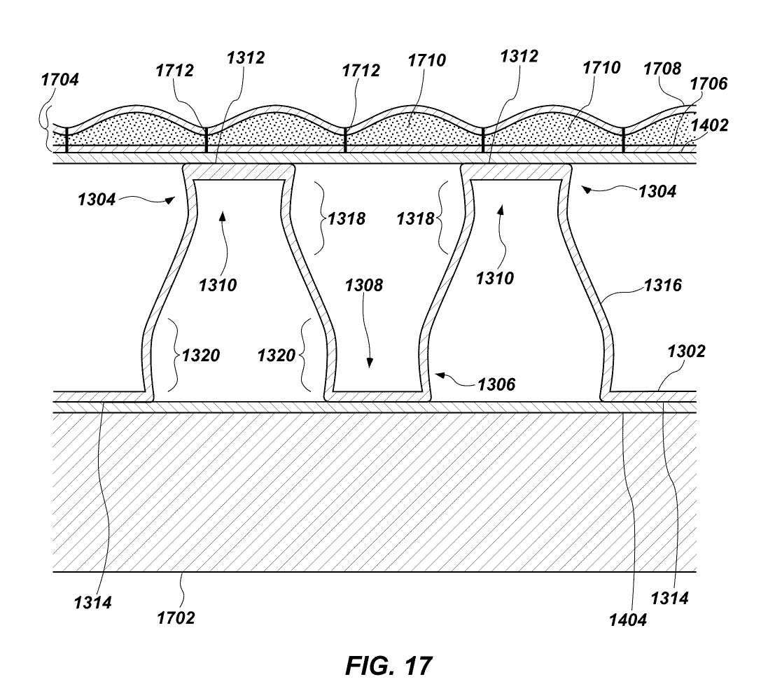

FIG. 15 shows another cushion or cushioning element. The cushion or cushioning element of FIG. 15 may be formed by bonding one or more additional cushioning materials attached to one or both of the flexible support members 1402 and 1404 of the cushioning element of FIG. 14. For example, another structured sheet 1302′ of gel cushioning material (like the sheet 1302 as previously described with reference to FIG. 13) may be bonded to the flexible support member 1404 on a side thereof opposite the sheet 1302. In some embodiments, the sheet 1302′ may be shaped and configured to match the features of the sheet 1302. For example, the sheet 1302′ may define protrusions and recesses, and may have sidewalls and endwalls. In such embodiments, the protrusions and endwalls of the sheet 1302′ may be aligned with the protrusions and endwalls of the sheet 1302, as shown in FIG. 15.

A third flexible support member 1504 may be attached to the sheet 1302′ on the side thereof opposite the flexible support member 1404. Additional cushioning materials (not shown) may be attached to produce a cushioning element of selected dimensions and properties. Cushioning materials may be attached to any of flexible support members 1402, 1404, and/or 1504.

In some embodiments, the sheet 1302′ may be replaced with a layer of coil springs, polyurethane foam, or any other cushioning material known in the art.

As shown in FIG. 15, a cover 1506 may be attached to the flexible support member 1402. The cover 1506 may include, for example, an impermeable material or a quilted material. In some embodiments, the cover 1506 may be present on both sides of the cushioning element. For example, the cover 1506 may entirely surround the gel cushioning element.

The structured sheets 1302, 1302′ of elastomeric gel may be formed by molding elastomeric gel between two molds, each having complementary features configured to define the protrusions and recesses on the opposing sides of the sheets 1302, 1302′. The molds may form approximately planar endwalls and sidewalls connecting the endwalls, as described above.

The elastomeric gel may be at least partially solidified within the mold cavity to form the structured sheets 1302, 1302′. For example, the elastomeric gel may cool, and may solidify, gel, stiffen, or set as it cools. The sheets 1302, 1302′ may retain all or a portion of the shape imparted to the elastomeric gel by the molds. The sheets 1302, 1302′ may be removed from the molds once they have solidified sufficiently so as to allow retention of their molded shapes as the sheets 1302, 1302′ are removed from the molds.

FIG. 16 shows another embodiment of a cushion or cushioning element. The cushion or cushioning element of FIG. 16 may be formed by bonding one or more additional cushioning materials to one or both of the flexible support members 1402 and 1404 of the cushioning element of FIG. 14. For example, a set of pocketed coil springs 1602 may be bonded to the flexible support member 1404. The set of pocketed coil springs 1602 may include a plurality of spring elements 1604, each contained within a flexible pocket 1606. In some embodiments, foam 1608 may be bonded to the flexible support member 1402. The foam 1608 may include, for example, a layer of polyurethane foam having a thickness of about 1 inch.

FIG. 17 shows another embodiment of a cushion or cushioning element. For example, cushion or cushioning element of FIG. 17 may be formed by bonding one or more additional cushioning materials to one or both of the flexible support members 1402 and 1404 of the cushioning element of FIG. 14. As shown in FIG. 17, a foam mattress base 1702 may be bonded to the flexible support member 1404. The foam mattress base 1702 may include a layer of polyurethane foam having a thickness of about 8 inches. In some embodiments and as depicted in FIG. 17, a quilted cover 1704 may be bonded to the flexible support member 1402. The quilted cover 1704 may include, for example, a first fabric 1706, a second fabric 1708, and a filling material 1710. The filling material 1710 may be retained between the first fabric 1706 and the second fabric 1708 by one or more fibers 1712.

Additional non-limiting example embodiments of the disclosure are described below.

### Embodiment 1

A gel cushioning element comprising a sheet of elastomeric gel. The sheet is shaped and configured to define a first plurality of protrusions on a first side of the gel cushioning element, a second plurality of protrusions on a second side of the gel cushioning element opposite the first side, a first plurality of recesses on the first side of the gel cushioning element, and a second plurality of recesses on the second side of the gel cushioning element. The recesses of the first plurality of recesses are aligned with and extend into the protrusions of the second plurality of protrusions, and the recesses of the second plurality of recesses are aligned with and extend into the protrusions of the first plurality of protrusions. The first plurality of protrusions and the second plurality of protrusions are configured to buckle in response to a pressure greater than a threshold pressure.

### Embodiment 2

The gel cushioning element of Embodiment 1, wherein the sheet of elastomeric gel comprises a first plurality of endwalls defining a portion of the first plurality of protrusions and a portion of the second plurality of recesses and having a first average endwall thickness. The sheet also comprises a second plurality of endwalls defining a portion of the second plurality of protrusions and a portion of the first plurality of recesses and having a second average endwall thickness.

### Embodiment 3

The gel cushioning element of Embodiment 2, wherein the sheet of elastomeric gel comprises sidewalls connecting the first plurality of endwalls to the second plurality of endwalls and having an average sidewall thickness less than or equal to the first average endwall thickness and less than or equal to the second average endwall thickness.

### Embodiment 4

The gel cushioning element of Embodiment 3, wherein at least one of the first average endwall thickness and the second average endwall thickness is at least 30% (thirty percent) larger than the average sidewall thickness.

### Embodiment 5

The gel cushioning element of Embodiment 4, wherein at least one of the first average endwall thickness and the second average endwall thickness is at least 10% (thirty percent) larger than the average sidewall thickness.

### Embodiment 6

The gel cushioning element of Embodiment 2, wherein each endwall of the first plurality of endwalls and each endwall of the second plurality of endwalls comprises a generally planar face.

### Embodiment 7

The gel cushioning element of Embodiment 6, wherein the sidewalls comprise a first plurality of generally cylindrical sidewall portions, each surrounding an endwall of the first plurality of endwalls, and a second plurality of generally cylindrical sidewall portions, each surrounding an endwall of the second plurality of endwalls.

### Embodiment 8

The gel cushioning element of Embodiment 7, wherein the first plurality of generally cylindrical sidewall portions has a first average minimum inside diameter, the second plurality of generally cylindrical sidewall portions has a second average minimum inside diameter, the first plurality of endwalls has a first average endwall diameter, the second plurality of endwalls has a second average endwall diameter, the first average endwall diameter is greater than the first average minimum inside diameter, and the second average minimum endwall diameter is greater than the second average minimum inside diameter.

### Embodiment 9

The gel cushioning element of any of Embodiments 1 through 8, wherein each protrusion of the first plurality of protrusions is disposed laterally adjacent a recess of the first plurality of recesses, and wherein each protrusion of the second plurality of protrusions is disposed laterally adjacent a recess of the second plurality of recesses.

### Embodiment 10

The gel cushioning element of any of Embodiments 1 through 9, further comprising a first fabric bonded to the sheet of elastomeric gel adjacent each protrusion of the first plurality of protrusions and a second fabric bonded to the sheet of elastomeric gel adjacent each protrusion of the second plurality of protrusions.

### Embodiment 11

The gel cushioning element of Embodiment 10, wherein at least one of the first fabric and the second fabric is bonded to at least one of another cushioning material and a cover.

### Embodiment 12

A method of forming a gel cushioning element comprising disposing elastomeric gel between a first mold having a first plurality of elevated features and a second mold having a second plurality of elevated features to impart an alternating pattern to the elastomeric gel, and hardening the elastomeric gel to form a sheet defining a first plurality of protrusions and a second plurality of protrusions. The first plurality of elevated features is facing the second plurality of elevated features, and each elevated feature of the first plurality is disposed adjacent an elevated feature of the second plurality. The first plurality of protrusions and the second plurality of protrusions are configured to buckle in response to a pressure greater than a threshold pressure.

### Embodiment 13

The method of Embodiment 12, further comprising removing the sheet from the first mold and the second mold.

### Embodiment 14

The method of Embodiment 12 or Embodiment 13, further comprising securing a first fabric to the sheet adjacent each protrusion of the first plurality of protrusions and securing a second fabric to the sheet adjacent each protrusion of the second plurality of protrusions.

### Embodiment 15

The method of Embodiment 14, wherein securing a first fabric to the sheet adjacent each protrusion of the first plurality of protrusions and securing a second fabric to the sheet adjacent each protrusion of the second plurality of protrusions each comprises heating the sheet to a temperature sufficient to fuse the first fabric and the second fabric to the elastomeric gel.

### Embodiment 16

The method of any of Embodiments 12 through 15, wherein disposing elastomeric gel between a first mold having a first plurality of elevated features and a second mold having a second plurality of elevated features to impart an alternating pattern to the elastomeric gel comprises forming a first plurality of recesses aligned with and extending into the second plurality of protrusions and forming a second plurality of recesses aligned with and extending into the first plurality of protrusions.

### Embodiment 17

The method of any of Embodiments 12 through 16, wherein disposing elastomeric gel between a first mold having a first plurality of elevated features and a second mold having a second plurality of elevated features to impart an alternating pattern to the elastomeric gel comprises forming a first plurality of approximately planar endwalls having a first endwall thickness, forming a second plurality of approximately planar endwalls having a second endwall thickness, and forming sidewalls connecting the first plurality of endwalls and the second plurality of endwalls, the sidewalls having an average sidewall thickness less than each of the first endwall thickness and the second endwall thickness.

### Embodiment 18

A cushion comprising a gel cushioning element comprising a sheet of elastomeric gel shaped and configured to define a first plurality of protrusions on a first side of the gel cushioning element, a second plurality of protrusions on a second side of the gel cushioning element opposite the first side, a first plurality of recesses on the first side of the gel cushioning element, and a second plurality of recesses on the second side of the gel cushioning element. A first fabric is bonded to the sheet of elastomeric gel adjacent the first plurality of protrusions, and a second fabric is bonded to the sheet of elastomeric gel adjacent the second plurality of protrusions. The recesses of the first plurality of recesses are aligned with and extend into the protrusions of the second plurality of protrusions, and the recesses of the second plurality of recesses are aligned with and extend into the protrusions of the first plurality of protrusions. The first plurality of protrusions and the second plurality of protrusions are configured to buckle in response to a pressure greater than a threshold pressure.

### Embodiment 19

The cushion of Embodiment 18, further comprising a second cushioning element bonded to the first fabric.

### Embodiment 20

The cushion of Embodiment 19, wherein the second cushioning element comprises a cushioning element selected from the group consisting of coil springs, foam, and gel cushioning elements.

### Embodiment 21

The cushion of Embodiment 19 or Embodiment 20, further comprising a third cushioning element bonded to the second fabric.

### Embodiment 22

The cushion of any of Embodiments 18 through 21, further comprising a cover over the first fabric, the gel cushioning element, and the second fabric.

### Embodiment 23

The cushion of Embodiment 22, wherein the cover is quilted.

While the present gel cushions, materials and methods for making the same have been described and illustrated in conjunction with a number of specific configurations, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

1. A gel cushioning element comprising:
a sheet of elastomeric gel shaped and configured to define:
a first plurality of protrusions on a first side of the gel cushioning element;
a second plurality of protrusions on a second side of the gel cushioning element opposite the first side;
a first plurality of recesses on the first side of the gel cushioning element; and
a second plurality of recesses on the second side of the gel cushioning element;
wherein the recesses of the first plurality of recesses are aligned with and extend into the protrusions of the second plurality of protrusions, and the recesses of the second plurality of recesses are aligned with and extend into the protrusions of the first plurality of protrusions; and
wherein the first plurality of protrusions and the second plurality of protrusions are configured to buckle in response to a pressure greater than a threshold pressure.

2. The gel cushioning element of claim 1, wherein the sheet of elastomeric gel comprises:
a first plurality of endwalls defining a portion of the first plurality of protrusions and a portion of the second plurality of recesses and having a first average endwall thickness; and
a second plurality of endwalls defining a portion of the second plurality of protrusions and a portion of the first plurality of recesses and having a second average endwall thickness.

3. The gel cushioning element of claim 2, wherein the sheet of elastomeric gel comprises sidewalls connecting the first plurality of endwalls to the second plurality of endwalls and having an average sidewall thickness less than or equal to the first average endwall thickness and less than or equal to the second average endwall thickness.

4. The gel cushioning element of claim 3, wherein at least one of the first average endwall thickness and the second average endwall thickness is at least 30% larger than the average sidewall thickness.

5. The gel cushioning element of claim 4, wherein at least one of the first average endwall thickness and the second average endwall thickness is at least 10% larger than the average sidewall thickness.

6. The gel cushioning element of claim 2, wherein each endwall of the first plurality of endwalls and each endwall of the second plurality of endwalls comprises a generally planar face.

7. The gel cushioning element of claim 6, wherein the sidewalls comprise:
a first plurality of generally cylindrical sidewall portions, each surrounding an endwall of the first plurality of endwalls; and
a second plurality of generally cylindrical sidewall portions, each surrounding an endwall of the second plurality of endwalls.

8. The gel cushioning element of claim 7, wherein:
the first plurality of generally cylindrical sidewall portions has a first average minimum inside diameter;
the second plurality of generally cylindrical sidewall portions has a second average minimum inside diameter;
the first plurality of endwalls has a first average endwall diameter;
the second plurality of endwalls has a second average endwall diameter;
the first average endwall diameter is greater than the first minimum average inside diameter; and
the second average endwall diameter is greater than the second average minimum inside diameter.

9. The gel cushioning element of claim 1, wherein each protrusion of the first plurality of protrusions is disposed laterally adjacent a recess of the first plurality of recesses, and wherein each protrusion of the second plurality of protrusions is disposed laterally adjacent a recess of the second plurality of recesses.

10. The gel cushioning element of claim 1, further comprising a first fabric bonded to the sheet of elastomeric gel adjacent each protrusion of the first plurality of protrusions and a second fabric bonded to the sheet of elastomeric gel adjacent each protrusion of the second plurality of protrusions.

11. The gel cushioning element of claim 10, wherein at least one of the first fabric and the second fabric is bonded to at least one of another cushioning material and a cover.

12. A method of forming a gel cushioning element comprising:
disposing elastomeric gel between a first mold having a first plurality of elevated features and a second mold having a second plurality of elevated features to impart an alternating pattern to the elastomeric gel, wherein the first plurality of elevated features is facing the second plurality of elevated features and each elevated feature of the first plurality is disposed adjacent an elevated feature of the second plurality; and
hardening the elastomeric gel to form a sheet defining a first plurality of protrusions and a second plurality of protrusions, wherein the first plurality of protrusions and the second plurality of protrusions are configured to buckle in response to a pressure greater than a threshold pressure.

13. The method of claim 12, further comprising removing the sheet from the first mold and the second mold.

14. The method of claim 12, further comprising securing a first fabric to the sheet adjacent each protrusion of the first plurality of protrusions and securing a second fabric to the sheet adjacent each protrusion of the second plurality of protrusions.

15. The method of claim 14, wherein securing a first fabric to the sheet adjacent each protrusion of the first plurality of protrusions and securing a second fabric to the sheet adjacent each protrusion of the second plurality of protrusions each comprises heating the sheet to a temperature sufficient to fuse the fabric to the elastomeric gel.

16. The method of claim 12, wherein disposing elastomeric gel between a first mold having a first plurality of elevated features and a second mold having a second plurality of elevated features to impart an alternating pattern to the elastomeric gel comprises forming a first plurality of recesses aligned with and extending into the second plurality of protrusions and forming a second plurality of recesses aligned with and extending into the first plurality of protrusions.

17. The method of claim 12, wherein disposing elastomeric gel between a first mold having a first plurality of elevated features and a second mold having a second plurality of elevated features to impart an alternating pattern to the elastomeric gel comprises:
forming a first plurality of approximately planar endwalls having a first endwall thickness;
forming a second plurality of approximately planar endwalls having a second endwall thickness; and
forming sidewalls connecting the first plurality of endwalls and the second plurality of endwalls, the sidewalls having an average sidewall thickness less than each of the first endwall thickness and the second endwall thickness.

18. A cushion, comprising:
a gel cushioning element comprising:
a sheet of elastomeric gel shaped and configured to define:
a first plurality of protrusions on a first side of the gel cushioning element;
a second plurality of protrusions on a second side of the gel cushioning element opposite the first side;
a first plurality of recesses on the first side of the gel cushioning element; and
a second plurality of recesses on the second side of the gel cushioning element;
wherein the recesses of the first plurality of recesses are aligned with and extend into the protrusions of the second plurality of protrusions, and the recesses of the second plurality of recesses are aligned with and extend into the protrusions of the first plurality of protrusions;
a first fabric bonded to the sheet of elastomeric gel adjacent the first plurality of protrusions; and
a second fabric bonded to the sheet of elastomeric gel adjacent the second plurality of protrusions;
wherein the first plurality of protrusions and the second plurality of protrusions are configured to buckle in response to a pressure greater than a threshold pressure.

19. The cushion of claim 18, further comprising a second cushioning element bonded to the first fabric.

20. The cushion of claim 19, wherein the second cushioning element comprises a cushioning element selected from the group consisting of coil springs, foam, and gel cushioning elements.

21. The cushion of claim 19, further comprising a third cushioning element bonded to the second fabric.

22. The cushion of claim 18, further comprising a cover over the first fabric, the gel cushioning element, and the second fabric.

23. The cushion of claim 22, wherein the cover is quilted.
